(19) United States
(12) Patent Application Publication
(10) Pub. No.: US 2004/0261939 A1
(43) Pub. Date: Dec. 30, 2004

(54) Cutting method and apparatus having a resilient insert

(75) Inventors: Richard John Ogle, Appleton, WI (US); Brian Thomas Roessler, Appleton, WI (US)

Correspondence Address: KIMBERLY-CLARK WORLDWIDE, INC., 401 NORTH LAKE STREET, NEENAH, WI, 54956

(73) Assignee: Kimberly-Clark Worldwide, Inc.

(21) Appl. No.: 10/608,692

(22) Filed: Jun. 26, 2003

(51) Int. Cl. B32B 31/00

(52) U.S. Cl. 156/269; 156/510; 156/523

(57) ABSTRACT

A cutter apparatus (20), comprises a rotary cutter (26) having an axis of rotation (28) and an outer peripheral, [circumferential] rim surface (30). A cutter array having at least one cutter die (32) can be located on the rim surface (30), and the cutter die (32) can have a die perimeter (34) and a die height (36). A resilient, primary insert (38) can be joined to the rotary cutter (26), and can be located within the die perimeter (34) operatively adjacent to said die perimeter (34). The primary insert (38) can have a primary-insert perimeter (40), and an operatively high-resistance to deformation.

### FIELD OF THE INVENTION

The present invention relates to a cutting system. More particularly, the present invention pertains to a rotary cutting system having a perimeter insert.

### BACKGROUND OF THE INVENTION

Conventional rotary cutting systems has been employed to cut article webs employed to produce personal care absorbent articles. Typical cutting systems have included rotary knife rolls and cooperating, rotary anvil rolls. The knife rolls have been configured to provide an array of cutting dies to provide cutting lines arranged with selected shapes. Other conventional cutting systems have included bonding components for providing construction bonds. In particular systems, the construction bonds have been located adjacent the regions of article webs where the article webs have been cut. Typically, the forming of the construction bonds and the cutting of the article webs have been conducted with separate and distinct processing operations. With conventional systems, the bonding operation has typically been performed prior to the cutting operation.

To maintain the integrity of the article web, conventional cutting systems have employed separate processing modules to perform the bonding and cutting operations. The separated operations have been employed to avoid an undesired breaking of one or more component layers of the article web at web locations that are remote from the desired cutting regions. The separate processing modules have contributed to increased complexity and cost, and have required increased amounts of space. As a result, there has been a continued need for cutting a method and apparatus that is more compact, and can provide increased reliability, increased efficiency and lower cost. Additionally, there has been a continuing need for an improved method and apparatus for reliably cutting an article web at high speeds while substantially avoiding any excessive breakage of the article web.

### BRIEF DESCRIPTION OF THE INVENTION

Generally stated, an apparatus aspect of the present invention can provide cutter apparatus, comprising a rotary cutter having an axis of rotation and an outer peripheral, rim surface. A cutter array having at least one cutter die can be located on the rim surface, and the cutter die can have a die perimeter and a die height. A resilient, primary insert can be joined to the rotary cutter, and can be located within the die perimeter operatively adjacent to said die perimeter. The primary insert can have a primary-insert perimeter, and an operatively high-resistance to deformation.

In a method aspect, the present invention can provide a cutting method, which comprises cutting an article web with a rotary cutter. The rotary cutter includes an axis of rotation and an outer peripheral, rim surface, and a cutter array has been located on the rim surface. The cutter array can have at least one cutter die, and the cutter die can have a die perimeter and a die height. A resilient, primary insert can be joined to the rotary cutter, and can be located within said die perimeter and operatively adjacent to the die perimeter. Additionally, the primary insert can have an operatively high resistance to deformation.

With its various aspects and configurations, the apparatus and method of the present invention can more efficiently and more effectively cut a target web. The cutting can be accomplished while substantially avoiding undesired breaks or fractures of component portions of the target web. The apparatus and method can also help eliminate the need for additional processing equipment, and can help reduce manufacturing costs.

### BRIEF DESCRIPTION OF THE DRAWINGS

FIG. 1 shows a schematic elevational view of a representative method and apparatus for selectively cutting an appointed target web.

FIG. 1A shows a schematic elevational view of a portion of a representative method and apparatus selectively cutting an appointed target web.

FIG. 2 shows a representative, partially cut-away, plan view of a bodyside of a representative web-segment or article that can be produced with the method and apparatus of the invention.

FIG. 2A shows a representative, partially cut-away, plan view of a garment-side of a representative web-segment or article that can be produced with the method and apparatus of the invention.

FIG. 2B shows a representative view of a transverse cross-section through a representative web-segment or article that can be produced with the method and apparatus of the invention.

FIG. 3 shows a top plan view of a representative cutting die system that can be employed with the present invention.

FIG. 3A shows a representative view of a length-wise cross-section of a rotary cutter having at least one segment which includes the cutting die system representatively shown in FIG. 3.

FIG. 3B shows a representative view of a transverse cross-section of a rotary cutter having at least one segment which includes the cutting die system representatively shown in FIG. 3.

FIG. 4 shows a representative top plan view of a rotary cutting die system arranged to provide a generally dog-bone shape.

### DETAILED DESCRIPTION OF THE INVENTION

It should be noted that, when employed in the present disclosure, the terms “comprises”, “comprising” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof.

As used herein, the term “nonwoven” refers to a fabric web that has a structure of individual fibers or filaments which are interlaid, but not in an identifiable repeating manner.

As used herein, the terms “spunbond” or “spunbonded fiber” refer to fibers which are formed by extruding filaments of molten thermoplastic material from a plurality of fine, usually circular, capillaries of a spinneret, and then rapidly reducing the diameter of the extruded filaments.

As used herein, the phrase “meltblown fibers” refers to fibers formed by extruding a molten thermoplastic material through a plurality of fine, usually circular, die capillaries as molten threads or filaments into a high velocity, usually heated, gas (e.g., air) stream which attenuates the filaments of molten thermoplastic material to reduce their diameter. Thereafter, the meltblown fibers are carried by the high velocity gas stream and are deposited on a collecting surface to form a web of randomly disbursed meltblown fibers.

“Coform” as used herein is intended to describe a blend of meltblown fibers and cellulose fibers that is formed by air forming a meltblown polymer material while simultaneously blowing air-suspended cellulose fibers into the stream of meltblown fibers. The meltblown fibers containing wood fibers are collected on a forming surface, such as provided by a foraminous belt. The forming surface may include a gas-pervious material, such as spunbonded fabric material, that has been placed onto the forming surface.

As used herein, the phrase “absorbent article” refers to devices which absorb and contain body liquids, and more specifically, refers to devices which are placed against or near the skin to absorb and contain the various liquids discharged from the body. The term “disposable” is used herein to describe absorbent articles that are not intended to be laundered or otherwise restored or reused as an absorbent article after a single use. Examples of such disposable absorbent articles include, but are not limited to: health care related products including surgical drapes, gowns, and sterile wraps; personal care absorbent products such as feminine hygiene products (e.g., sanitary napkins, pantiliners, tampons, interlabial devices and the like), infant diapers, children's training pants, adult incontinence products and the like; as well as absorbent wipes and covering mats.

Disposable absorbent articles such as, for example, many of the feminine care absorbent products, can include a liquid pervious topsheet, a substantially liquid impervious backsheet joined to the topsheet, and an absorbent core positioned and held between the topsheet and the backsheet. The topsheet is operatively permeable to the liquids that are intended to be held or stored by the absorbent article, and the backsheet may be substantially impermeable or otherwise operatively impermeable to the intended liquids. The absorbent article may also include other components, such as liquid wicking layers, liquid distribution layers, barrier layers, and the like, as well as combinations thereof.

Disposable absorbent articles and the components thereof, can operate to provide a body-facing surface and a garment-facing surface. As used herein, “body-facing surface” means that surface of the article or component which is intended to be disposed toward or placed adjacent to the body of the wearer during ordinary use, while the “outward surface” or “outward-facing surface” is on the opposite side, and is intended to be disposed to face away from the wearer's body during ordinary use. The outward surface may be arranged to face toward or placed adjacent to the wearer's undergarments when the absorbent article is worn.

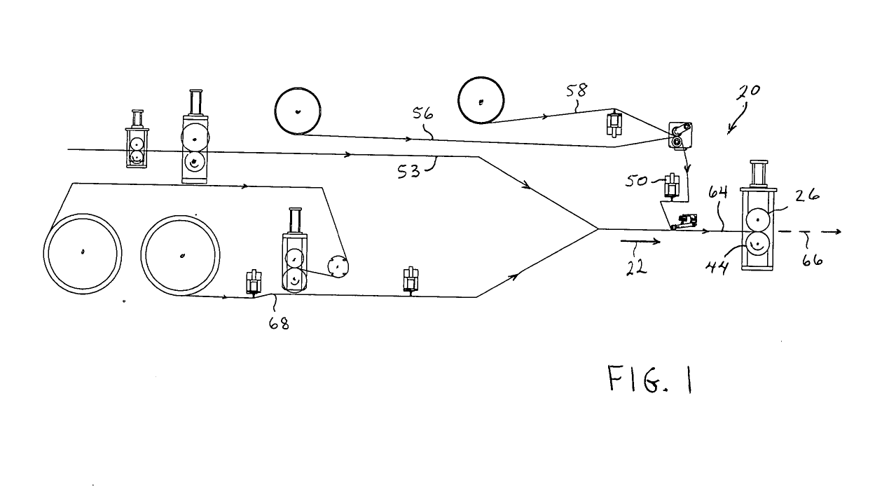

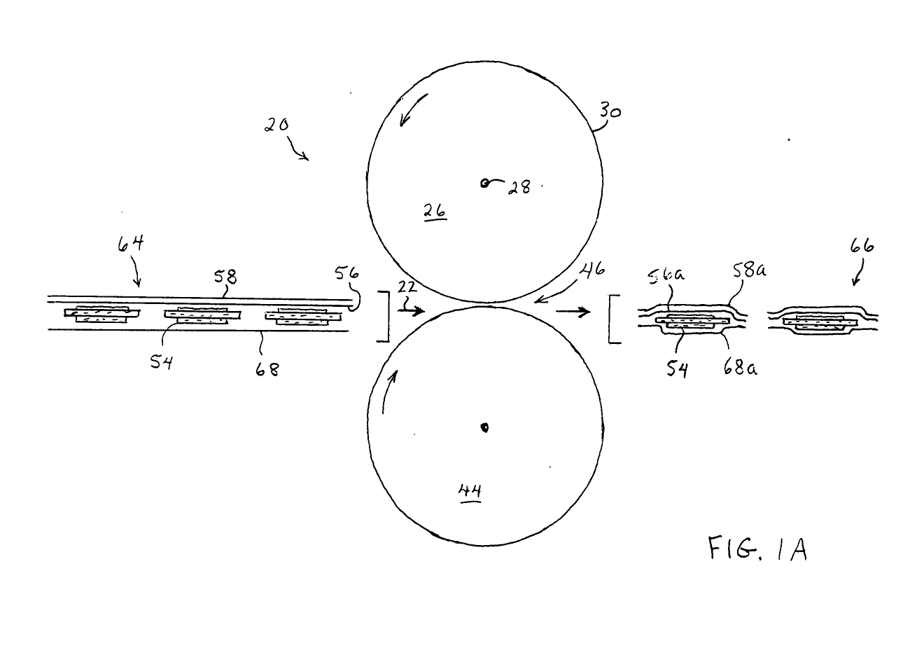

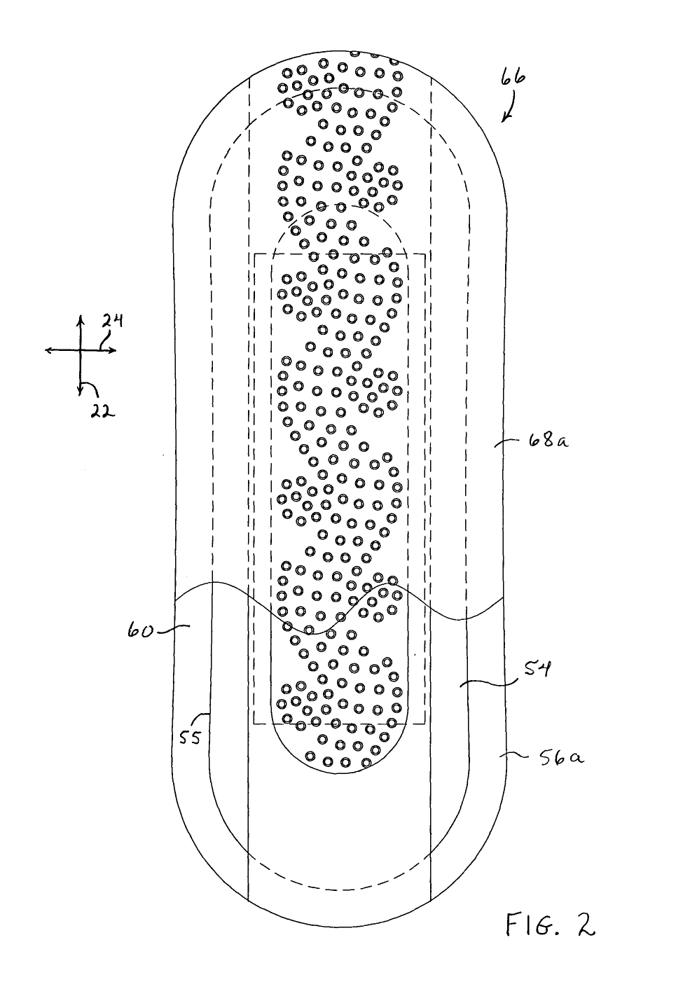

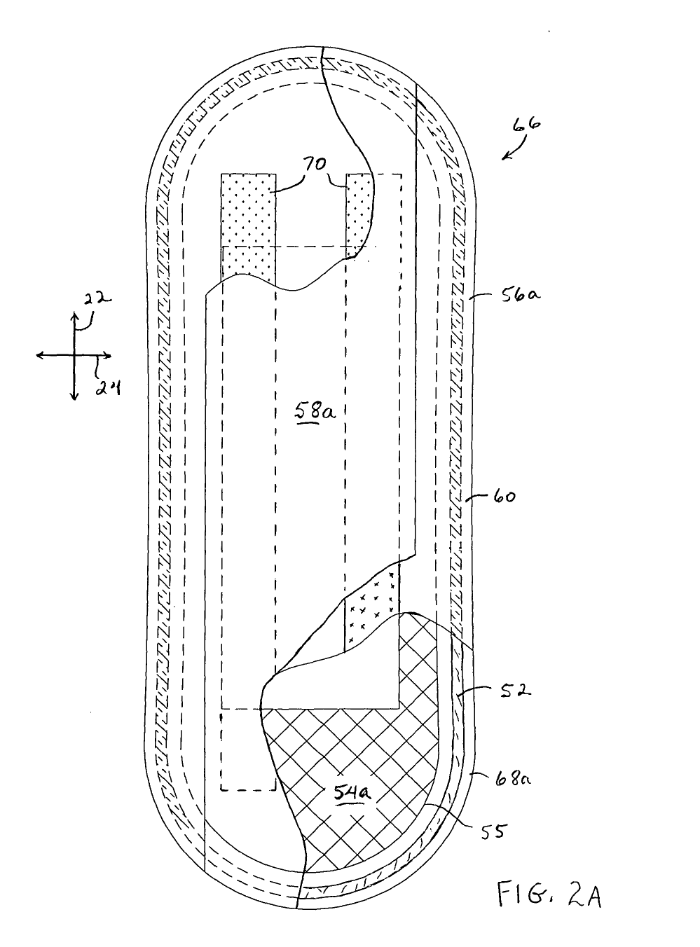

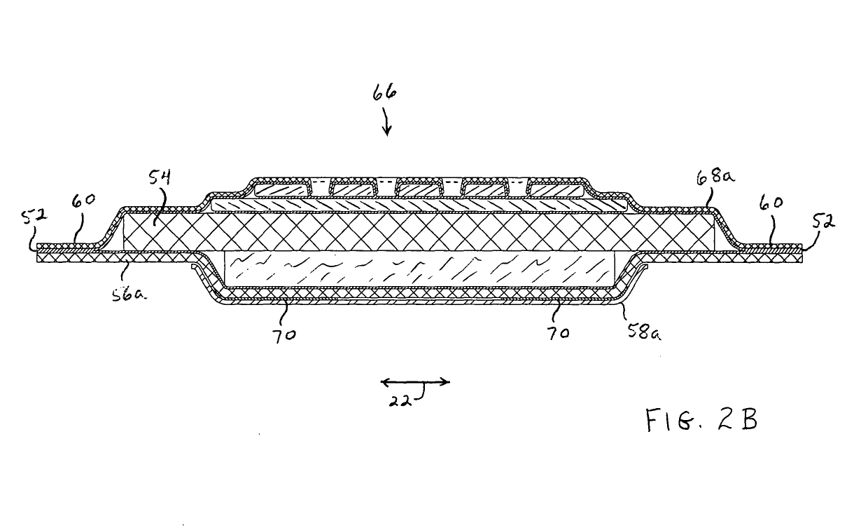

With reference to FIGS. 1 and 2, the method and apparatus of the invention can have an appointed machine-direction 22 which extends longitudinally, and an appointed lateral cross-direction 24 which extends transversely. For the purposes of the present disclosure, the machine-direction 22 is the direction along which a particular component or material is transported length-wise along and through a particular, local position of the apparatus and method. The cross-direction 24 lies generally within the plane of the material being transported through the method and apparatus, and is aligned perpendicular to the local machine-direction 22. Accordingly, in the view of the arrangement representatively shown in FIG. 1, the cross-direction 24 extends perpendicular to the plane of the sheet of the drawing.

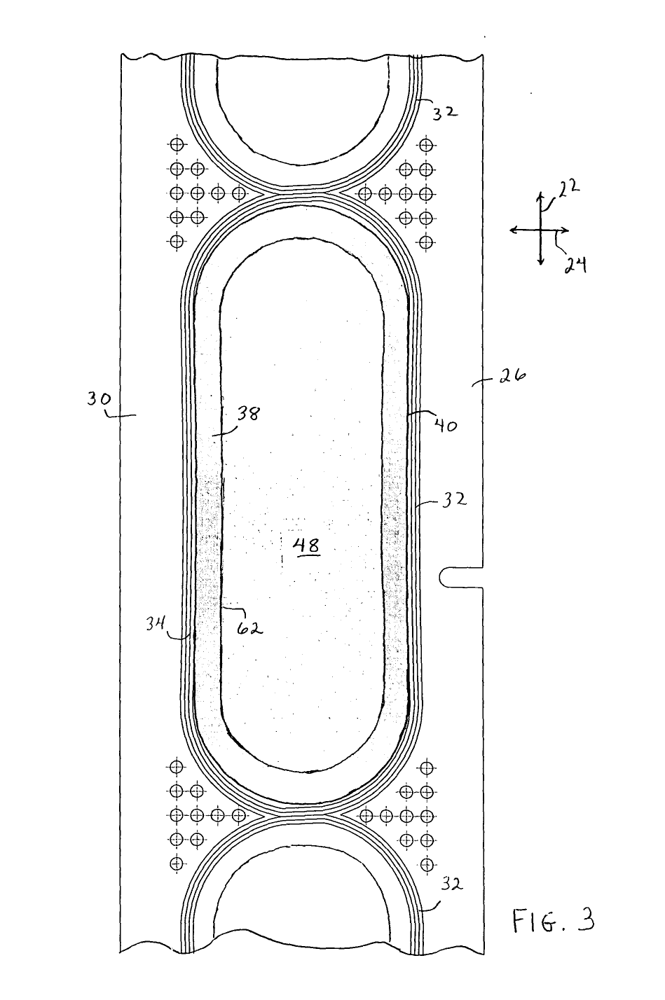

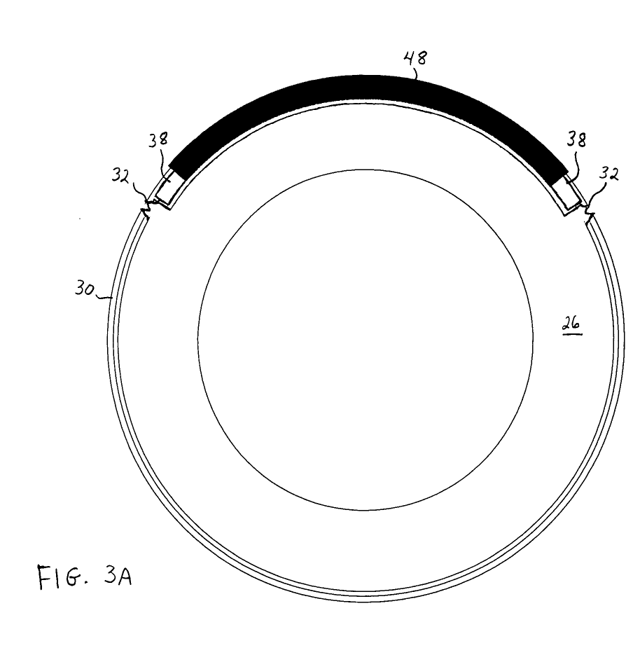

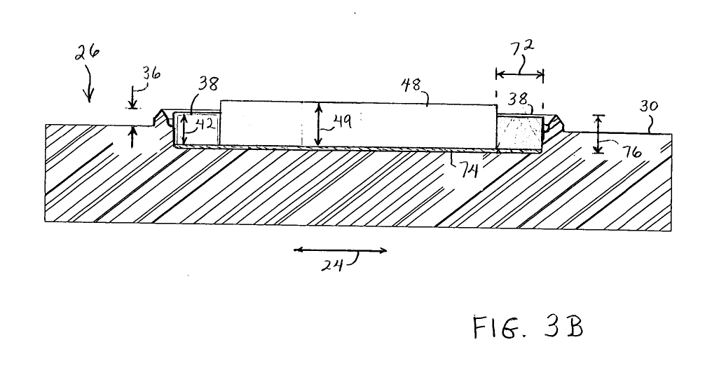

With reference to FIGS. 1 and 1A, the cutter apparatus 20 can include a rotary cutter 26 having an axis of rotation 28 and an outer peripheral, rim surface 30. As representatively shown, the rim surface can extend axially and circumferentially along the outer surface of the rotary cutter. A cutter array can have at least one cutter die 32 and can be operatively located on the rim surface 30, as representatively shown in FIGS. 3 through 3B. Additionally, the cutter die 32 can have a die perimeter 34 and a die height 36. A resilient, primary insert 38 can be joined to the rotary cutter 26, and can be located within the die perimeter 34 operatively adjacent to said die perimeter 34. The primary insert 38 can also have a primary-insert perimeter 40, and an operatively high-resistance to deformation.

The cutter method includes a cutting of a target, article web 64 with the rotary cutter 26. The rotary cutter 26 includes an axis of rotation 28, and an outer peripheral rim surface 30. A selected cutter array has been located on the rim surface 30. The cutter array has at least one cutter die 32, and the cutter die has a die perimeter 34 and a die height 36. A resilient, primary insert 38 has been joined to the rotary cutter 26, and has been located within the die perimeter 34 and operatively adjacent to the die perimeter. Additionally, the primary insert 38 has been configured with an operative, high-resistance to deformation.

In a particular aspect of the invention, the primary insert can have a selected stiffness parameter. Another aspect of the invention can include an arrangement in which the primary insert has been configured to produce or otherwise provide for a selected perimeter bond. In a still another aspect, the apparatus and method can include a secondary insert member. A further aspect can be configured to provide a target web having a component layer which exhibits a relatively low-toughness, or a relatively low-strength.

The rotary cutter 26 can be operatively configured to separate the article web 64 into a plurality of individual articles 66. The cutting method and apparatus can further include an anvil 44 which has been configured to cooperate with the rotary cutter component 26 to provide an operative cutting region 46 which is located in a region between the rotary cutter 26 and the anvil 44. The cutter 26 and anvil 44 can be cooperatively arranged and configured to separate the desired articles 66 from the article web 64 in a desired manner. The anvil 44 can be provided by any operative component structure or mechanism. Additionally, the anvil 44 can have a substantially smooth anvil surface, or may have a patterned anvil surface. For example, the cooperating anvil surface can have a pattern that operatively matches the selected shape of the cutter die 32. As representatively shown, the anvil 44 can be a rotary anvil which is operatively rotatable about an anvil axis of rotation and positioned operatively adjacent the rotary cutter 26. The anvil can be configured to counter-rotate relative to the rotary cutter 26, and the cutting region 46 can be a nip region that is positioned between the rotary cutter 26 and the counter-rotating anvil 44. Accordingly, the article web 64 can operatively move at a selected cutting speed through the nip region 46. Conventional rotary anvils are well known and are available from commercial vendors.

By incorporating its various aspects, features and configuration, alone or in combination, the apparatus and method of the present invention can more efficiently and more effectively cut a target web. The cutting can be accomplished while substantially avoiding undesired breaks or fractures of component portions of the target web. The apparatus and method can also help eliminate the need for additional processing equipment, and can help reduce manufacturing costs.

With reference to FIGS. 1 and 1A, the target, article web 64 can be configured to move at a selected speed along the machine-direction 22 of the apparatus and method. The article web can include a substrate layer 56, and a first component layer 58. The article web 64 can further include a second component layer 68, and a plurality of individual absorbent members 54. The absorbent members can, for example, be produced from one or more webs of absorbent material 53 provided by conventional supply mechanisms. The absorbent members can be positioned at spaced-apart locations along the longitudinal, machine-direction 22, and can be sandwiched between the substrate layer 56 and the second component layer 68. The target, article web 64 can also include other web components or layers, as desired. The representatively shown substrate layer 56 can extend substantially continuously along a longitudinal machine-direction 22 of the cutting method and apparatus. Similarly, the representatively shown first component layer 58 and/or the representatively shown second component layer 68 can extend substantially continuously along the longitudinal machine-direction 22 of the cutting method and apparatus.

In the construction of the article web 64, the various components may be assembled and held together with any operative securement mechanism or system. For example, the desired attachments or securements can include adhesive bonds, cohesive bonds, thermal bonds, ultrasonic bonds, pins, snaps, staples, rivets, stitches, welds, zippers, or the like, as well as combinations thereof.

As representatively shown in FIGS. 1, 1A, 2 and 2A, the article web 64 can be cut or otherwise divided to provide individual web segments or articles 66, such as the representatively shown feminine care article. The feminine care article can, for example, be a feminine care pad or panty-liner, and the article can have a lengthwise-dimension along the longitudinal direction 22, and a transverse-dimension along the laterally extending, cross-direction 24. Additionally, the article can include a topsheet or cover layer 68a, a baffle layer 56a, and an absorbent structure member 54 positioned between the cover layer and baffle layer. In particular configurations, the feminine care article 66 can include one or more regions of conventional garment-adhesive 70 that can be employed to secure the article 66 to a wearer's undergarment during use. Additionally, the article can include a conventional release sheet 58a that covers the garment-adhesive when the article is packaged or otherwise stored prior to actual use by the wearer. The release sheet can be readily removed prior to placing the article in the wearer's undergarment.

As representatively shown in the arrangement of the illustrated example, the substrate layer 56 can be employed to provide the baffle layer 56a of the individual article; the second component layer 68 can be employed to provide the cover layer 68a of the article; and the first component layer 58 can be employed to provide the release sheet layer 58a of the article.

The article 66 can further include a selected, operative pattern of adhesive 52a that has been distributed between the baffle layer 56a and the cover layer 68a. The adhesive pattern may be regular or irregular, and may be continuous or discontinuous, as desired. The adhesive can, for example, be distributed along at least along a portion of an appointed bonding region 60a of the article or article segment. As representatively shown, the bonding region 60a can extend along and generally adjacent to at least a portion of a perimeter or border edge of each individual absorbent member 54. Accordingly, portions of the appointed bonding region 60a can be located to extend laterally adjacent to the individual absorbent member 54. It should be readily appreciated that the article 66 may also include other, additional components, such as side-panel or wing portions (not shown) which can be selectively arranged and configured to extend from lateral, side regions of the article. The side-panel portions-can be selectively arranged to extend inwardly toward or outwardly away from a longitudinally extending centerline of the article, as desired.

With reference to FIGS. 1 and 1A, the material of the substrate layer 56 can be delivered into the method and apparatus from a suitable supply source, and an operative adhesive, can be employed to assemble together the various components of the desired article web 64. In a particular aspect, the article web 64 can include a selected pattern of adhesive 52 that has been distributed between the second component layer 68 and the substrate layer 56. The adhesive can, for example, be distributed along at least along a portion of an appointed bonding region 60 of the article web.

Any operative adhesive applicator 50 may be employed. Suitable applicators can include adhesive spray devices, adhesive coating devices, adhesive printing devices, or the like, as well as combinations there of. Any operative adhesive may be employed. Suitable adhesives can, for example, include hot melt adhesives, pressure-sensitive adhesives, solvent-based adhesives, pressure-sensitive adhesives, or the like as well as combinations thereof.

Various known, conventional mechanisms can be employed to position individual absorbent members 54 at spaced apart locations along the machine-direction 22 of the method and apparatus. Additionally, the selected second component layer 68 may be assembled with the substrate layer 56 and the absorbent members 54 by employing known, conventional mechanisms. As representatively shown, the substrate layer 56 and the absorbent members 54 may be superposed onto the second component layer 68. Other operative arrangements may optionally be employed, as desired.

As illustrated in the arrangement representatively shown in FIG. 1, the adhesive applicator 50 can be configured to deposit a selected pattern of adhesive 52 to join a plurality of individual absorbent members 54 between the second component layer 68 and the substrate layer 56. The absorbent members 54 can be positioned at spaced-apart locations along the longitudinal, machine-direction of the method and apparatus and along the machine-direction of the composite article web 64. At least an operative portion of the adhesive pattern 52 can be distributed along an appointed bonding region 60 of the article web 64, and can be distributed between the second component layer 68 and the substrate layer 56. As representatively shown, the bonding region 60 can extend along and generally adjacent to at least a portion of a perimeter or border edge of an individual absorbent member 54. Accordingly, at least a portion of the selected bonding regions 60 can be positioned along and between the individual absorbent members 54. Additionally, portions of the appointed bonding regions 60 can be located laterally adjacent to each of the individual absorbent members 54.

The second component layer 68 and the cover component 68a may be constructed of any operative material, and may be a composite material. For example, the substrate layer can include a woven fabric, a nonwoven fabric, a polymer film, or the like, as well as combinations thereof. Examples of a nonwoven fabric include, spunbond fabric, meltblown fabric, coform fabric, a carded web, a bonded-carded-web, or the like as well as combinations thereof. For example, the substrate layer can include a woven fabric, a nonwoven fabric, a polymeric film that has been configured to be operatively liquid-permeable, or the like, as well as combinations thereof. Other examples of suitable materials for constructing the substrate layer can include rayon, bonded carded webs of polyester, polypropylene, polyethylene, nylon, or other heat-bondable fibers, polyolefins, such as copolymers of polypropylene and polyethylene, linear low-density polyethylene, aliphatic esters such as polylactic acid, finely perforated film webs, net materials, and the like, as well as combinations thereof.

A more particular example of a suitable second component layer material can include a bonded-carded-web composed of polypropylene and polyethylene, such as has been used as a cover stock for KOTEX brand pantiliners, and has been obtainable from Vliesstoffwerk Christian Heinrich Sandler GmbH & Co. KG, a business having an address at Postfach 1144, D95120 Schwarzenbach/Saale, Germany. Other examples of suitable materials are composite materials of a polymer and a nonwoven fabric material. The composite materials are typically in the form of integral sheets generally formed by the extrusion of a polymer onto a web of spunbond material. In a desired arrangement, the second component layer 68 can be configured to be operatively liquid-permeable with regard to the liquids that the article is intended to absorb or otherwise handle. The operative liquid-permeability may, for example be provided by a plurality of pores, perforations, apertures or other openings, as well as combinations thereof, that are present or formed in the substrate layer. The apertures or other openings can help increase the rate at which bodily liquids can move through the thickness of the substrate layer and penetrate into the other components of the article (e.g. into the absorbent structure 54). The selected arrangement of liquid-permeability is desirably present at least on an operative portion of the second component layer that is appointed for placement on the body-side of the article. The second component layer 68 can provide comfort and conformability, and can function to direct bodily exudates away from the body and toward the absorbent structure 54. In a desired feature, the second component layer 68 can be configured to retain little or no liquid in its structure, and can be configured to provide a relatively comfortable and non-irritating surface next to the body-tissues of a female wearer. The substrate layer 56 can be constructed of any material which is also easily penetrated by bodily fluids that contact the surface of the cover layer.

The second component layer 68 can also have at least a portion of its bodyside surface treated with a surfactant to render the cover more hydrophilic. The surfactant can permit arriving bodily liquids to more readily penetrate the cover layer. The surfactant may also diminish the likelihood that the arriving bodily fluids, such as menstrual fluid, will flow off the cover layer rather than penetrate through the cover layer into other components of the article (e.g. into the structure of the absorbent body 54). In a particular configuration, the surfactant can be substantially evenly distributed across at least a portion of the bodyside surface of the second component layer 68 that overlays the bodyside surface of the absorbent.

The second component layer 68 may be maintained in an operatively secured relation with the absorbent structure 54 by bonding all or a portion of the adjacent surfaces to one another. A variety of bonding mechanisms or systems known to one of skill in the art may be utilized to achieve any such secured relation. Examples of such mechanisms or systems include, but are not limited to, the application of adhesives in a variety of patterns between the two adjoining surfaces, entangling at least portions of the adjacent surface of the absorbent with portions of the adjacent surface of the cover, or fusing at least portions of the adjacent surface of the cover to portions of the adjacent surface of the absorbent.

The second component layer 68 typically extends over the bodyside surface of the absorbent structure, but can alternatively extend around the article to partially or entirely, surround or enclose the absorbent structure. Alternatively, the second component layer 68 and the substrate layer 56 can have peripheral margins which extend outwardly beyond the terminal, peripheral edges of the absorbent structure 54, and the extending margins can be operatively joined together to partially or entirely, surround or enclose the absorbent structure.

The substrate layer 56 and baffle 56a may be constructed of any operative material, and may or may not be configured to be liquid-permeable. In a particular configuration, the substrate layer 56 may be configured to provide a desired level of liquid-impermeability. The substrate layer may, for example, include a polymeric film, a woven fabric, a nonwoven fabric or the like, as well as combinations or composites thereof. For example, the first component layer may include a polymer film laminated to a woven or nonwoven fabric. In a particular feature, the polymer film can be composed of polyethylene, polypropylene, polyester or the like, as well as combinations thereof. Additionally, the polymer film may be micro-embossed. Desirably, the substrate layer 56 can operatively permit a sufficient passage of air and moisture vapor out of the article, particularly out of an absorbent (e.g. storage or absorbent structure 54) while blocking the passage of bodily liquids. An example of a suitable first component layer material can include a breathable, microporous film, such as a HANJIN Breathable baffle material available from Hanjin Printing, Hanjin P&C Company Limited, a business having offices located in Sahvon-li.Jungan-mvu.Kongiu-City, Chung cheong nam-do, Republic of South Korea. The baffle material is a breathable film, which is white in color, dimple embossed., and contains: 47.78% calcium carbonate, 2.22% TiO₂, and 50% polyethylene.

In a particular feature, the polymer film can have a minimum thickness of no less than about 0.025 mm, and in another feature, the polymer film can have a maximum thickness of no greater than about 0.13 mm. Bicomponent films or other multi-component films can also be used, as well as woven and/or nonwoven fabrics which have been treated to render them operatively liquid-impermeable. Another suitable first component layer material can include a closed cell polyolefin foam. For example, a closed cell polyethylene foam may be employed. Still another example of a first component layer material would be a material that is similar to a polyethylene film which is used on commercially sold KOTEX brand pantiliners, and is obtainable from Pliant Corporation, a business having offices located in Schaumburg, Ill., USA.

The absorbent member 54 can include a single absorbent component, or may include a plurality of absorbent components to provide a desired absorbent composite. For example, the absorbent composite can, for example, include an intake layer, a distribution layer, and/or a shaping layer which are arranged in conventional configurations that are well known in the art. The structure of the absorbent body 54 can include a matrix of absorbent fibers and/or absorbent particulate material, and the absorbent fiber can include natural or synthetic fiber.

The structure of the absorbent member 54 may also include superabsorbent material. Superabsorbent materials suitable for use in the present invention are known to those skilled in the art. As a general rule, the water-swellable, generally water-insoluble, hydrogel-forming polymeric absorbent material (superabsorbent) is capable of absorbing at least about 10, desirably about 20, and possibly about 100 times or more its weight in water. The hydrogel-forming polymeric absorbent material may be formed from organic hydrogel-forming polymeric material, which may include natural material such as agar, pectin, and guar gum; modified natural materials such as carboxymethyl cellulose, carboxyethyl cellulose, and hydroxypropyl cellulose; and synthetic hydrogel-forming polymers. Synthetic hydrogel-forming polymers include, for example, alkali metal salts of polyacrylic acid, polyacrylamides, polyvinyl alcohol, ethylene maleic anhydride copolymers, polyvinyl ethers, polyvinyl morpholinone, polymers and copolymers of vinyl sulfonic acid, polyacrylates, polyacrylamides, polyvinyl pyridine, and the like. Other suitable hydrogel-forming polymers include hydrolyzed acrylonitrile grafted starch, acrylic acid grafted starch, and isobutylene maleic anhydride copolymers and mixtures thereof. The hydrogel-forming polymers are preferably lightly crosslinked to render the material substantially water insoluble. Crosslinking may, for example, be by irradiation or covalent, ionic, Van der Waals, or hydrogen bonding. Suitable materials are available from various commercial vendors such as The Dow Chemical Company, Hoechst Celanese Corporation, Allied Colloid Inc., and Stockhausen, Inc.

The first component layer 58 may composed of paper, polymer film, woven fabric, nonwoven fabric or the like, as well as combinations thereof. For example the first component layer may be a layer of release material, and may be employed to provide the release sheet component 58a of an individual article. In a particular aspect, the first component layer may be TEKKOTE 24 KSA—24# peel release material which is available from Tekkote Corporation, a business having offices located in Leonia, N.J., U.S.A.

In particular arrangements, at least one of the component layers of the article web 64 can have a relatively low-toughness. The component layer may have a relatively low-strength, and/or may be relatively more brittle with a relatively low elongation-at-break. The low-toughness component layer may, for example, be provided by the first component layer 58. Optionally, the relatively low-toughness layer may be provided by another component layer of the article web 64.

The relatively low-toughness web material can, for example, have a tensile strength which can be as low as about 15 pounds per inch of cross-direction length (about 26 N/cm). The tensile strength of the web material can alternatively be as low as about 18 lb/in (about 31 N/cm), and can optionally be as low as about 20 lb/in (about 35 N/cm). In other aspects, the first component layer can have a tensile strength which is up to a maximum about 50 pounds per inch of cross-direction length (about 88 N/cm). The tensile strength of the low-toughness web material can alternatively be up to about 45 lb/in (about 79 N/cm), and can optionally be up to about 40 lb/in (about 70 N/cm).

The rotary cutter 26 can have any operative shape. As representatively shown, the rotary cutter 26 can be provided by a rotatable roll or wheel. Additionally, the rotary cutter can be substantially circular or noncircular, as desired. Any conventional driving system may be employed to operatively rotate the cutter 26 and coordinate the operation of the cutter with the movement of the target web 64. Such systems are well known and available from commercial vendors.

With reference to FIGS. 1A and 3-3B, the outer peripheral rim surface 30 can extend along the axial and circumferential directions of the rotary cutter 26. As representatively shown, the axial direction of the rotary cutter 26 can be aligned substantially parallel to the local cross-direction 24 of the method and apparatus 20.

The rotary cutter can have any operative diameter. In particular arrangements, for example, the rotary cutter 26 can have a roll diameter within the range of about 8-13 inches (about 20-33 cm). Any operative number of cutter dies can be distributed along the outer circumference of the rotary cutter. In particular arrangements, for example, the number of distributed cutter dies can be within the range of about 1-6.

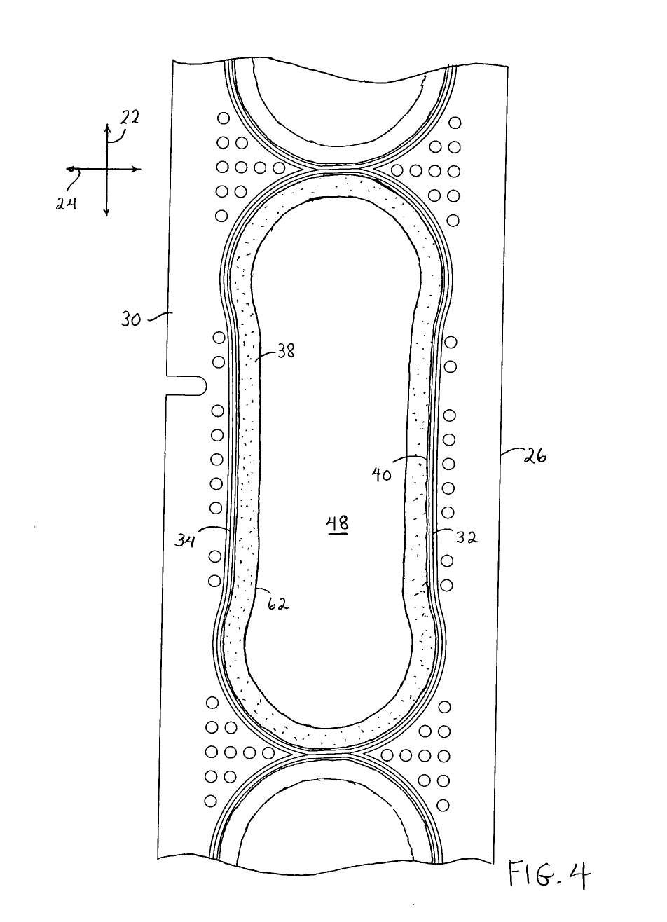

The cutter die 32 can have any desired shape or configuration. The shape of the cutter die 32 can be regular or irregular, and can be continuous or discontinuous, as desired. As representatively shown, the cutter die 32 can have a pair of laterally opposed, cutter side-portions which extend generally along the longitudinal machine-direction 22, and a longitudinally opposed pair of cutter end-portions which extend generally laterally along the cross-direction 24. The side-portions and end-portions of the cutter die 32 can desirably be configured to provide a cutting shape having a border edge which forms a desired outline shape. For example, the cutter die can be arranged to provide a symmetrical shape, an asymmetrical shape, a regular or irregular rectilinear shape, a regular or irregular curvilinear shape or the like, as well as combinations thereof. In particular arrangements, the cutter die can be configured to provide the individual article 66 with a substantially closed-shape, such as the representatively shown race-track shape (e.g. FIG. 3), a generally “dog-bone” shape (e.g. FIG. 4) or the like, as well as combinations thereof.

A selected array of at least one cutter die 32, and desirably a plurality of cutter dies may be arranged and distributed along the outward surface of the circumferentially-extending outer rim 30 of the rotary cutter 26. The selected array cutter dies may be regular or irregular, and may be distributed along the axial dimension and/or circumferential dimension of the rotary cutter, as desired.

The cutter die 32 can have a corresponding die border or perimeter 34, and can have a corresponding die height 36 (e.g. FIG. 3B). A resilient primary insert 38 can be operatively joined to the rotary cutter 26, and can be located within and inside the boundary of the die perimeter 34. The primary insert can be located in an operative pocket region that is formed into the surface of the rotary cutter to provide a suitable pocket depth 76. Additionally, the primary insert 38 can be selectively positioned operatively adjacent to the die perimeter. The primary insert can have a primary-insert perimeter 40 which includes a terminal edge (e.g. FIG. 3). Additionally, the primary insert can include a generally peripheral, interior boundary or border region 62.

The primary insert 38 can have any operative primary-insert height 42. As representatively shown, the primary-insert height 42 can be less than the die height 36. Alternatively, the primary-insert height 42 can be substantially equal to, or greater than the cutter die height 36.

The primary insert 38 can also have any operative cross-sectional shape. The representatively shown configuration has a substantially rectangular cross-sectional shape. Alternatively, the cross-sectional shape of the primary insert can be trapezoidal, pyramidal, polygonal, circular, elliptical, domed, annular, tubular or the like, as well as combinations thereof.

In particular aspects, the primary-insert 38 can be operatively compressible and re-expandable. The resilient primary insert 38 is compressible upon the application of a selected, relatively high, compression force or pressure, and is re-expandable upon the removal of the compression force or pressure. In a particular configuration, the primary-insert may, for example, include a relatively stiff, cross-linked polyethylene foam material, urethane foam material, or other polymer foam material.

In another aspect, the primary-insert 38 can have an operative, relatively high-resistance to deformation. In a particular feature, the primary die insert 38 can include a material having a selected Compression Deflection property. In particular aspects, the relatively high-stiffness, die insert 38 can have a Compression Deflection property, at 10% deflection, of at least a minimum of about 10 psi (69 KPa). The Compression Deflection property can alternatively be at least about 20 psi (138 KPa), and can optionally be at least about 30 psi (207 KPa) or at least about 35 psi (241 KPa) to provide improved performance. A desired arrangement can, for example exhibit a Compression Deflection property of at least about 40 psi (276 KPa). In other aspects, the Compression Deflection property can be up to a maximum of about 200 psi (1379 KPa), or more. The Compression Deflection property can alternatively be up to about 100 psi (689 KPa), and can optionally be up to about 70 psi (483 KPa) to provide improved effectiveness. A desired arrangement can, for example, exhibit a Compression Deflection property of up to about 45 psi (310 KPa).

For the various materials set forth in the present disclosure, the compression deflection property can be determined in accordance with ASTM Designation D3575-93, “Standard Test Methods for Flexible Cellular Materials Made from Olefin Polymers”, “Suffix B—Compression Set Under Constant Deflection”, Sep. 15, 1993.

The relatively high resistance to deformation provided by the primary insert 38 can provide a desired high force and pressure to a component that is being processed by the method and apparatus of the invention. As representatively shown, the high resistance to deformation provided by the primary insert 38 can produce a desired, relatively high force and pressure to predetermined regions of an article web 64.

The resilient, primary-insert 38 can be configured to provide for a perimeter bond 60a which extends relatively outboard from and along at least a portion of the border or perimeter region 55 of each absorbent member 54. The perimeter bond can be formed during the cutting of the article web 64 with the rotary cutter 26. In a desired arrangement, the primary-insert 38 can be configured to provide a pressure and/or pressuring force that is sufficient to provide an operative perimeter bond 60a during the operation of the cutting method and apparatus. In particular, the stiffness and thickness of the primary-insert can be appropriately coordinated with the thickness of the article web 64 to operatively provide the desired cutting operation in combination with the desired bonding operation. The thickness of the primary insert should be large enough to generate the desired bonding. The thickness of the primary insert, however, should not be so large that the primary insert interferes with the desired cutting operation. If the primary insert is too large and/or too stiff, the cutting edge of the cutter die can be excessively forced away from the target web, and the cutting operation can become erratic.

A suitable technique for adjusting the components to generate the desired perimeter bond can include the following:

Determine the thicknesses of the portions of the target web that are to be cut or bonded;

Determine the pocket depth (76) that is formed and available in the rotary cutter;

Determine the forces and pressures required to generate the desired cutting and bonding operations;

Determine the amount of deflection of the stiff, primary insert material that is required to generate the force and pressure required to produce the desired bonding operation;

Select the thickness of the stiff, primary-insert (38) material such that the required amount of compressed deflection is generated during the cutting and bonding process.

In another feature, the resilient primary-insert 38 can rapidly return from its deformed, compressed shape and size to substantially its original, undeformed shape and size. In particular, the primary-insert can rapidly return from its deformed, compressed thickness to substantially its original, uncompressed thickness. The primary-insert can desirably exhibit a recovery-time of greater than zero and not more than a maximum of about 1 sec. The recovery-time can be not more than about 0.5 sec, can alternatively be not more than about 0.15 sec, and can optionally be not more than about 0.1 sec to provide improved performance.

If the thickness and/or the resilient deformation property of the primary-insert 38 is outside the desired parameters, various shortcomings may occur. For example, the primary-insert 38 may not adequately provide the desired pressuring force and bonding operation during high-speed operations, or may excessively interfere with the desired cutting operation.

In a particular aspect, the primary-insert 38 can be configured to help provide a desired perimeter bond 60a. A desired arrangement can alternatively include a primary-insert having a generally annular configuration in which an interior region of the primary-insert 38 is an open area in the primary-insert and in which the primary insert provides an extending, interior border region 62 of the primary-insert. The open area can, for example, be constructed and arranged to be approximately the same size and shape as the selected absorbent member 54. Additionally, the border region 62 of the primary-insert can operatively engage the article web 64 along regions of the article web that extend generally adjacent to and away from an individual absorbent member 54, and can apply the pressuring forces needed to generate the desired perimeter bond 60a which can extend around and relatively outboard from its corresponding, individual absorbent member. As representatively shown, for example, the primary-insert border region 62 can be configured as a strip that extends generally adjacent to and relatively inboard from the cutter die 32. Other operative configurations of the primary-insert 38 may optionally be employed, as desired.

In a particular feature, the primary-insert 38 can help to stabilize the article web 64 during the cutting operation, and can help to reduce stresses in the article web. At high cutting speeds, the cutting operation can generate very high, impact loads and stresses on the moving article web 64. The configurations of the invention, such as the configurations of the primary-insert 38, can help to spread and distribute the stresses in the article web that are generated during the cutting operation. As a result, the cutting operation can be conducted with a reduced likelihood of undesirably breaking or fracturing one or more components of the article web.

In another aspect, the cutting method and apparatus can further include a supplemental-insert 48 which is located within the borders of the primary-insert perimeter 40. The supplemental-insert 48 may, for example, be arranged to overlie the primary-insert 38. A desired arrangement can alternatively include a primary-insert having a substantially annular configuration in which an interior region of the primary-insert 38 has been removed to leave an open area. Accordingly, the supplemental-insert can be configured to occupy the open area within the primary-insert. In its various configurations, the terminal, outer peripheral edge of the supplemental-insert 48 can be spaced-away, relatively inboard from the terminal, outer peripheral edge of the primary-insert 38 by a selected spacing distance 72. Accordingly, the supplemental-insert can be configured to substantially avoid operating in the border region 62 of the primary-insert. The spacing distance can be provided along the entire annular configuration of the primary-insert, or along a selected portion of the annular configuration of the primary-insert, as desired. In a desired aspect the spacing distance 72 (and “width” of the border region 62) can be at least a minimum of about 0.5 mm. The spacing distance can alternatively be at least about 1 mm, and can optionally be at least about 1.5 mm to provide improved performance. In other aspects, the spacing distance 72 can be up to a maximum of about 25 mm, or more. The spacing distance can alternatively be up to about 20, and can optionally be up to about 15 mm to provide improved effectiveness and cost efficiency. In a desired arrangement, the spacing distance 72 can be up to about 10 mm. The spacing distance is configured to generate an operative bond along appointed portions of the outer, peripheral margins of the article. In desired arrangements, for example, the spacing distance 72 can allow the border region 62 of the primary insert to operatively generate an operative bond along the peripheral margins of the article. Desirably, the peripheral bond can have a peel strength which is at least a minimum of about 150 grams. If the spacing distance is outside the described values, the desired bonding of the article components can be degraded, or an excessive amount of material may be employed in the peripheral margins of the manufactured product.

The supplemental insert 48 can have any operative supplemental-insert height 49. In a particular aspect, the supplemental-insert height 49 can be greater than the primary-insert height 42. The supplemental-insert height 49 can alternatively be substantially equal to or less than the primary-insert height 42, as desired.

The relatively lower resistance to deformation exhibited by the supplemental-insert 48 can be configured to help accommodate an increased thickness or bulk arising from the presence of the absorbent member 54. By readily allowing the bulkier region of the article web to readily move into the volume vacated by the displaced supplemental-insert, the cutter die can more efficiently and more effectively cut the desired, target regions of the article web 64. Additionally, the resilient force provided by the displaced supplemental-insert 48 can help urge a cut portion of the article web away from the cutter die 32, and away from the rotary cutter 26. In a particular configuration, the supplemental-insert 48 can, for example, include an acoustical foam, such as provided by an open cell, flexible polyester-based urethane foam.

The primary insert 38 and/or the supplemental insert 48 can be permanently or removably attached to the rotary cutter 26. A removable and/or refastenable attachment system can facilitate the maintenance and repair of worn or damaged insert members. Any operative securement mechanism 74 (e.g. FIG. 3B) may be employed to provide the desired attachments. The securement mechanism may, for example, include an adhesive, a cohesive, a interengaging mechanical fastener component, a hook component of a hook-and-loop type fastener, or the like, as well as combinations thereof.

In the cutting method and apparatus, the rotary cutter 26 can be configured to provide a rotary-cutter surface speed which is at least a minimum of about 195 cm/sec (centimeters per second). The rotary-cutter surface speed can alternatively be at least about 225 cm/sec, and can optionally be at least about 250 cm/sec to provide improved performance. In other aspects, the rotary-cutter surface speed can be up to a maximum of about 510 cm/sec, or more. The rotary-cutter surface speed can alternatively be up to about 450 cm/sec, and can optionally be up to about 360 cm/sec to provide improved efficiency. In a desired configuration, the surface speed of the rotary cutter 26 can be about 306 cm/sec.

It has been found that at high rotary cutter speeds there can be an excessive fracture or breakage of one or more component layers of the article web 64. By employing the various configurations and features of the invention, the method and apparatus for reliably cutting an article web at high speeds while substantially avoiding any excessive breakage of the article web.

The following Example describes particular configurations of the invention, and is presented to provide a more detailed understanding of the invention. The Examples are not intended to limit the scope of the present invention in any way. From a complete consideration of the entire disclosure, other arrangements within the scope of the claims will be readily apparent to one skilled in the art.

### EXAMPLE 1

An array of shaped cutter dies were serially distributed along the outer circumference of a rotary cutter roll. In a particular arrangement, an array of three cutter dies were substantially equally spaced along the circumference of a cutter roll. A generally annular, primary-insert was positioned and secured within the perimeter boundary of each cutter die. A supplemental-insert was positioned and secured within the perimeter of each primary-insert, and the terminal edge of each supplemental-insert was spaced-away from the outboard terminal edge of its corresponding primary-insert by a distance 72 (e.g. FIG. 3B) of approximately 0.25 inch (about 0.64 cm).

The distal cutting edge of the cutter die extended beyond and above the exposed, outer surface of the rotary cutter with a die height 36 which was within the range of about 0.190-0.130 inch (about 0.48-0.33 cm). Additionally, the primary-insert had a thickness height of about 1 cm (about 0.38 inch), and the supplemental-insert had a thickness height of about 1 cm (about 0.38 inch), as determined when the primary-insert and supplemental-insert were at their non-compressed, resting condition.

The primary-insert included a microcellular, urethane polymer foam, which was designated GREEN GORILLA foam material and was obtained from Monroe Rubber & Plastic, Inc., a business having offices located in Monroe, Mich. 18161, U.S.A. In a particular arrangement, the foam had a thickness of about 1 cm (about 0.38 inch). This relatively high-stiffness material exhibited the following parameters:

Compression Deflection at 25% deflection: 63 psi (434 KPa);

Density: X-X-Firm;

Durometer “A”: 40-50.

Additionally, the high-stiffness material exhibited a Compression Deflection property at 10% deflection of about 40-45 psi (about 276-310 KPa). A pressure of about 40-45 psi (about 276-310 KPa) was needed to provide a 10% compressive deflection of the material, (ASTM Designation D3575-93, “Standard Test Methods for Flexible Cellular Materials Made from Olefin Polymers”, “Suffix B—Compression Set Under Constant Deflection”).

The supplemental-insert included an acoustical foam, which was provided by an open cell, flexible polyester-based urethane foam. This relatively low-stiffness material had a density of about 1.8-2.2 lb/ft³ (about 0.03-0.04 g/cm³) and a tensile strength of about 20 psi (138 KPa). Additionally, this material had a tear strength of about 1.6 lb/in (about 0.29 kg/cm), and could provide an elongation of about 200%.

Those skilled in the art will recognize that the present invention is capable of many modifications and variations without departing from the scope thereof. Accordingly, the detailed description and examples set forth above are meant to be illustrative only and are not intended to limit, in any manner, the scope of the invention as set forth in the appended claims.

1. A cutter apparatus, comprising
a rotary cutter having an axis of rotation and an outer peripheral, rim surface;
a cutter array having at least one cutter die located on said rim surface, said cutter die having a die perimeter and a die height;
a resilient, primary insert which is joined to said rotary cutter and is located within said die perimeter and operatively adjacent to said die perimeter, said primary insert having a primary-insert perimeter and an operatively high resistance to deformation.

2. A cutter apparatus as recited in claim 1, further including an anvil which is configured to cooperate with said rotary cutter component to provide a cutting region in a region between said rotary cutter and said anvil.

3. A cutter apparatus as recited in claim 1, wherein said primary insert has a substantially annular configuration.

4. A cutter apparatus as recited in claim 1, wherein said primary insert has a primary-insert height which is less than said die height.

5. A cutter apparatus as recited in claim 1, wherein said primary insert includes a material having a resilient Compression Deflection, at 10% deflection, which is at least about 69 KPa.

6. A cutter apparatus as recited in claim 1, wherein said primary die insert includes a material having a resilient Compression Deflection, at 10% deflection, which is at least about 207 KPa.

7. A cutter apparatus as recited in claim 1, further including a supplemental insert which is located within said primary-insert perimeter, wherein
said primary-insert has a primary-insert height;
said supplemental insert has a relatively lower resistance to deformation, as compared to said primary insert, and
said supplemental-insert has a supplemental-insert height which is relatively higher than said primary-insert height.

8. A cutter apparatus as recited in claim 1, wherein said rotary cutter is configured to provide a rotary-cutter surface speed of at least about 195 cm/sec.

9. A cutter apparatus as recited in claim 1, wherein said primary insert has been configured to provide a pressure that is sufficient to provide an operative perimeter bond during the operation of said cutting method.

10. A cutter apparatus as recited in claim 1, further including an adhesive applicator which deposits a pattern of adhesive to join a plurality of individual absorbent members between a first component layer and a substrate layer with said absorbent members positioned at spaced-apart locations along a longitudinal direction; said pattern of adhesive distributed at least along a portion of a bonding region, and distributed between said first component layer and said substrate layer.

11. A cutting method, comprising
cutting an article web with a rotary cutter;
wherein
said rotary cutter includes an axis of rotation and an outer peripheral, rim surface;
a cutter array has been located on said rim surface, said cutter array having at least one cutter die, and said cutter die having a die perimeter and a die height;
a resilient, primary insert has been joined to said rotary cutter and has been located within said die perimeter and operatively adjacent to said die perimeter, said primary insert having an operatively high resistance to deformation.

12. A method as recited in claim 11, wherein said primary die insert has primary insert has a substantially annular configuration.

13. A method as recited in claim 11, wherein said primary insert provides a resilient Compression Deflection, at 10% deflection, which is at least about 69 KPa.

14. A method as recited in claim 11, wherein said primary insert provides a resilient Compression Deflection, at 10% deflection, which is at least about 207 KPa.

15. A method as recited in claim 11, wherein said article web has included a relatively low-toughness, second component layer which extends substantially continuously along a longitudinal direction of said cutting method.

16. A method as recited in claim 15, wherein said second component layer has a tensile strength of not more that about 26 N/cm.

17. A method as recited in claim 15, wherein said article web has further included
a substrate layer; and
a plurality of individual absorbent members which have been positioned at spaced-apart locations along said longitudinal direction, and have been sandwiched between said first component layer and said substrate layer.

18. A method as recited in claim 17, wherein said article web further includes
a first component layer, and
a pattern of adhesive that has been distributed at least along a portion of a bonding region of the article web, and between said first component layer and said substrate layer.

19. A method as recited in claim 18, wherein said resilient, primary insert has been configured to provide for a perimeter bond along at least a portion of a perimeter region of at least a one of said absorbent members during said cutting of the article web with the rotary cutter.

20. A method as recited in claim 17, wherein said primary insert has been configured to provide a pressure that is sufficient to provide an operative perimeter bond during the operation of said cutting method.

21. A method as recited in claim 11, wherein said rotary cutter has provided a rotary-cutter surface speed of at least about 195 cm/sec.

22. A method as recited in claim 11, wherein
a supplemental insert which has been located within a primary-insert perimeter;
said primary-insert has been provided with a primary-insert height;
said supplemental insert has been provided with a relatively lower resistance to deformation, as compared to said primary insert; and
said supplemental-insert has a supplemental-insert height which is relatively higher than said primary-insert height.
